(19) United States
(12) Patent Application Publication
(10) Pub. No.: US 2011/0068577 A1
(43) Pub. Date: Mar. 24, 2011

(54) Apparatus for providing overload protection for wind power generator and method thereof

(75) Inventors: Tzu-Yao Huang, Taichung City (TW); Shie-Li Jan, Taichung City (TW)

(73) Assignee: Hiwin Mikrosystem Corp.

(21) Appl. No.: 12/586,258

(22) Filed: Sep. 18, 2009

(51) Int. Cl. H02P 9/04

(52) U.S. Cl. 290/44

(57) ABSTRACT

An apparatus for providing overload protection of a wind power generator and a method thereof are disclosed. When the wind power generator is exposed to wind force excesses a preset safety threshold, the apparatus is started to rotate a fan set and a nacelle of the wind power generator, so as to pose a rotational plane of a fan set parallel to the wind direction.

### BACKGROUND OF THE INVENTION

1. Technical Field

The present invention relates to apparatuses for protecting wind power generators, and more particularly, to an apparatus allows a fan set and a nacelle of a wind power generator to automatically change direction when the fan set encounters a wind force exceeding a preset safety threshold for protecting the wind power generator.

2. Description of Related Art

It is known that a wind power generator serves to convert a mechanical energy generated by a wind-driven fan set into electrical power and save such electrical power in a battery. While the wind power generator is designed to operate under a wind force below a recognized safety threshold, the optimum wind power conversion rate can be achieved when the fan set has its rotational plane set perpendicular to the direction the wind comes in, hereafter referred to as the wind direction.

Conventionally, when the wind power generator faces a wind speed higher than the safety threshold, a brake system built in the nacelle of the wind power generator will automatically start to stop the operation of the wind power generator so as to protect the fan set and other mechanical parts from being broken or being destroyed due to overload.

In the traditional technology, the brake systems can be classified into the electromagnetic type and the mechanical type. The former costs highly and fails to work without power supply. The latter relies on complicated mechanical structure and requires frequent maintenance. In either case, an excessive wind force can burden the brake system and once the brake system fails, the wind power generator is exposed to the risks of broken fan set, destroyed mechanisms, and even leaned or collapsed tower of the wind power generator.

### SUMMARY OF THE INVENTION

In view of that the traditional brake systems fail to provide adequate protection to wind power generators under excessive wind force, the present invention proposes an approach to reduce the load on a brake system of a wind power generator, so as to provide protection to the wind power generator under excessive wind force.

The objective of the present invention is to provide an apparatus for providing overload protection for a wind power generator, wherein the apparatus starts when the wind power generator is expose to a wind force greater than a preset safety threshold so as to rotate a fan set of the wind power generator and such pose the fan set that a rotational plane of the fan set is parallel to the wind direction, thus reducing a windward area of the fan set, reducing a rotation rate of the fan set, decreasing the load on a brake system, and in turn preventing the wind power generator from being damaged by the excessive wind force.

In the present invention, an apparatus for providing overload protection for a wind power generator comprises: an aerovane assembled to the wind power generator for generating signals related to wind direction and wind velocity; a processor assembled to the wind power generator and coupled with the aerovane for receiving the signals related to wind direction and wind velocity, determining an off angle for a nacelle of the wind power generator to deflect accordingly, and converting the off angle into an off-angle signal; and a steering controller assembled to the wind power generator for controlling the nacelle to deflect, wherein the steering controller is coupled with the processor for receiving the off-angle signal and deflect the nacelle accordingly by the off angle.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawing, wherein:

FIG. 1 is a perspective view of a wind power generator having an apparatus for providing overload protection of the present invention taken from a first viewpoint;

FIG. 2 is another perspective view of the wind power generator having the apparatus for providing overload protection of the present invention taken from a second viewpoint;

FIG. 3 is a partially enlarged view an area circled in FIG. 1;

FIG. 4 shows the wind power generator having the apparatus for providing overload protection of the present invention with a rotational plane of its fan set perpendicular to the wind direction, assuming that a wind force is under a safety threshold; and

FIG. 5 shows the wind power generator having the apparatus for providing overload protection of the present invention with the rotational plane of its fan set parallel to the wind direction, assuming that the wind force thereon excesses a safety threshold.

### DETAILED DESCRIPTION OF THE PREFERRED EMBODIMENT

While a preferred embodiment provided hereinafter for illustrating the concept of the present invention as described above, it is to be understood that the components of the embodiment shown in the accompanying drawings are depicted for the sake of easy explanation and need not to be made in scale.

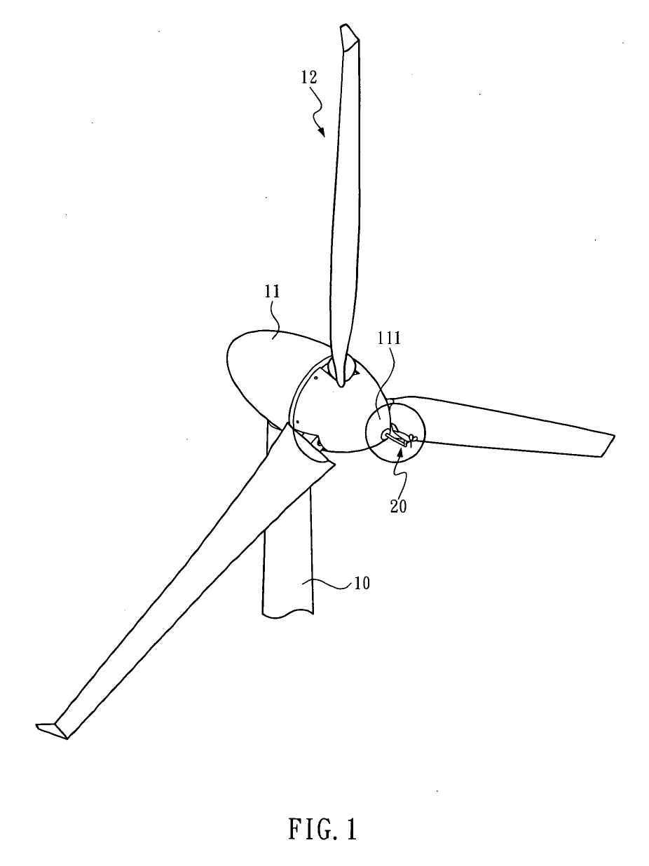

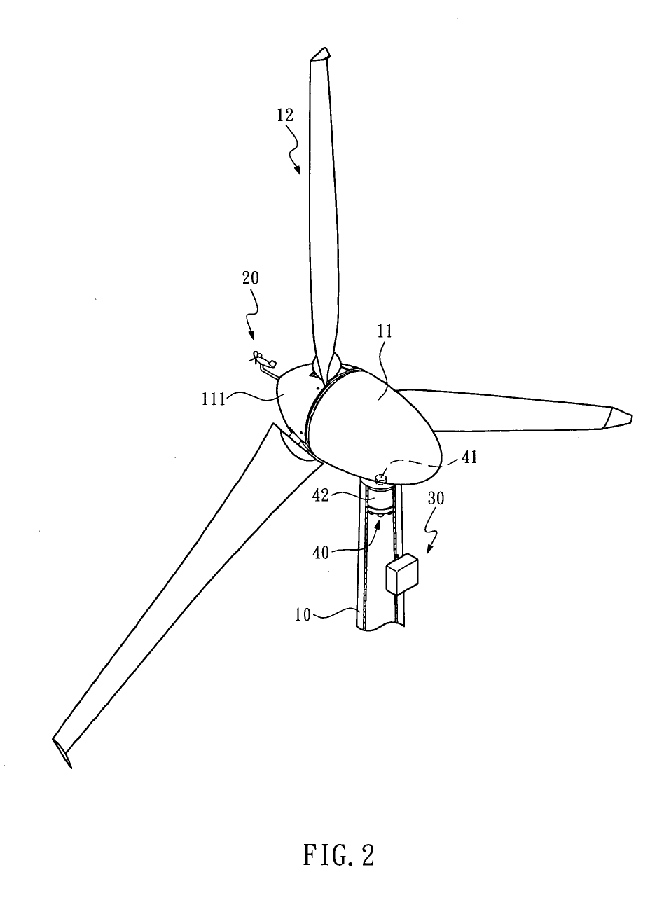

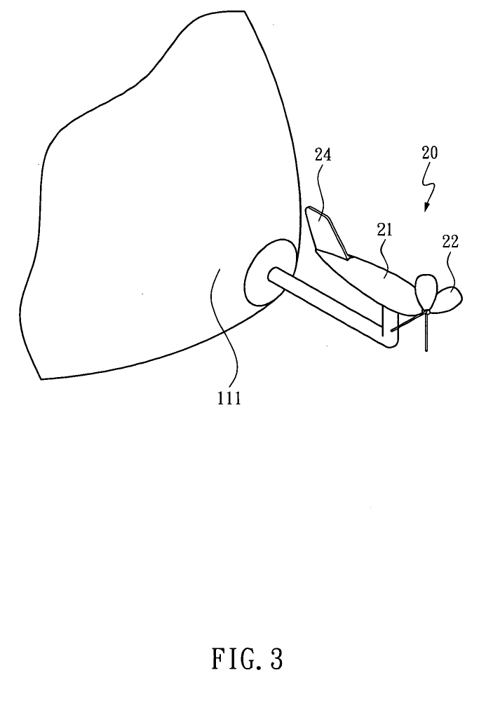

Referring to FIGS. 1 through 3, an apparatus for providing overload protection for a wind power generator is illustrated. The wind power generator includes a tower 10 with a top thereof mounted with a nacelle 11, which has a fan set 12 provided at a front end thereof. The generation device and brake system inside the nacelle 11 as well as the connection between the both and the fan set 12 are known to one skilled in the art and need not to be described in any length herein.

The apparatus of the present invention includes an aerovane 20, a processor 30, and a steering controller 40. The aerovane 20 is positioned at a front windward end 111 of the nacelle 11 while the processor 30 is fixed to the tower 10 and coupled with the aerovane 20. The steering controller 40 is herein realized by a direct-drive motor 42 mounted on a top of the tower 10 and has a driving shaft 41 connected to the nacelle 11 for controlling the nacelle 11 to rotate by a predetermined angle.

The aerovane 20 is a known device. It substantially has a streamlined body 21 that has a front end equipped with a four-blade propeller 22 as a wind velocity sensor and has a rear end provided with an empennage 24 as a wind direction sensor. The aerovane 20 serves to detect wind velocity and wind direction, and to generate and transmit signals related to wind direction and wind velocity to the processor 30. The processor 30 then uses its built-in program to calculate an off angle for the nacelle 11 to deflect according to the signals, and transmits an off-angle signal related to the off angle to a controller of the direct-drive motor 42, so that the direct-drive motor 42 is actuated by the controller to rotate its driving shaft 41 and in turn rotate the nacelle 11 by the off angle.

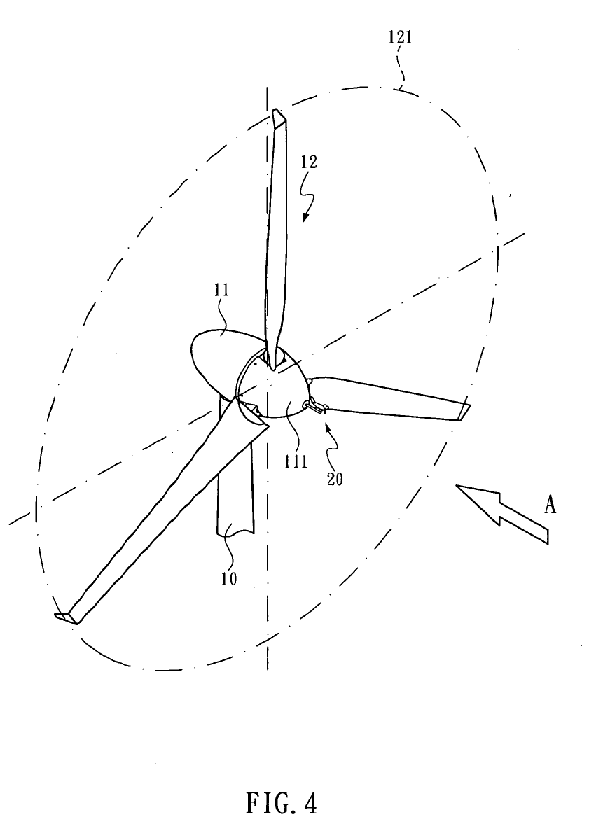

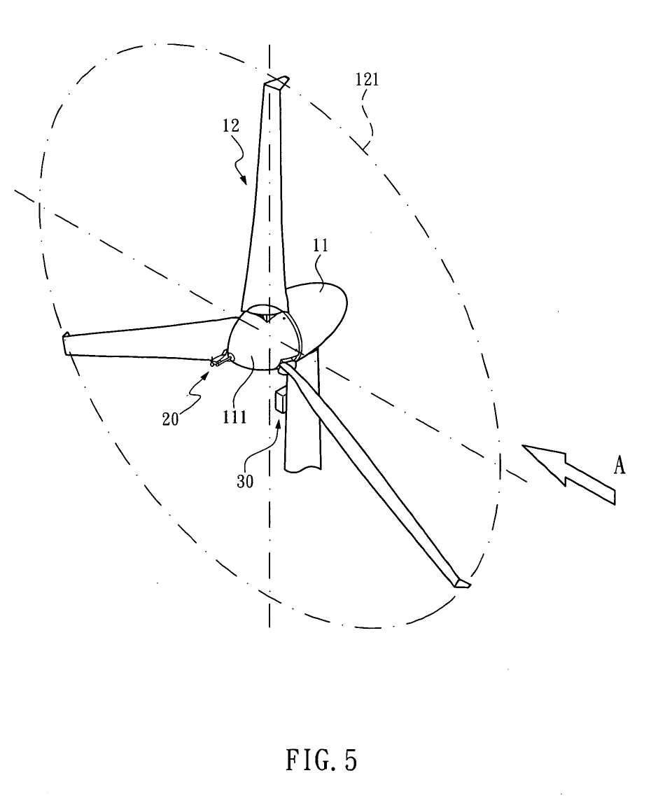

When a rotational plane 121 of the fan set 12 is perpendicular to the wind direction (as indicated by Arrow A), the fan set is posed at its optimum windward position, as shown in FIG. 4. When the rotational plane 121 of the fan set 12 is parallel to the wind direction, the fan set is disabled to acquire the wind force. Basing on this principle, according to FIG. 5, when the wind force detected by the aerovane 20 is greater than a preset safety threshold, the steering controller 40 controls the nacelle 11 to rotate by the determined off angle so as to pose the rotational plane 121 of the fan set 12 parallel to the wind direction (as indicated by Arrow A), causing the fan set not to acquire the wind force and reducing its rotation rate, thereby preventing the fan set 12 from rotating out of control or breaking due to overload, in turn unburdening the brake system and the tower 10 so as to prevent the tower 10 from leaning or collapsing under excessively strong wind.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. An apparatus for providing overload protection for a wind power generator, the apparatus comprising:
an aerovane assembled to the wind power generator for generating signals related to wind direction and wind velocity;
a processor assembled to the wind power generator and coupled with the aerovane for receiving the signals related to wind direction and wind velocity, determining an off angle for a nacelle of the wind power generator to deflect accordingly, and converting the off angle into an off-angle signal; and
a steering controller assembled to the wind power generator for controlling the nacelle to deflect, wherein the steering controller is coupled with the processor for receiving the off-angle signal and deflect the nacelle accordingly by the off angle.

2. The apparatus of claim 1, wherein the aerovane is positioned at a front windward end of the nacelle.

3. The apparatus of claim 1, wherein processor is mounted on a tower of the wind power generator.

4. The apparatus of claim 1, wherein the steering controller is a direct-drive motor.

5. The apparatus of claim 4, wherein the direct-drive motor is mounted on a top of a tower of the wind power generator with a driving shaft thereof connected to the nacelle.

6. A method for providing overload protection of a wind power generator by using the apparatus of claim 1, the method comprising:
making the steering controller to control the nacelle to deflect according to the off-angle signal of the processor so as to pose a rotational plane of the fan set of the wind power generator parallel to the wind direction.
